(19) United States
(12) Patent Application Publication
(10) Pub. No.: US 2023/0354444 A1
(43) Pub. Date: Nov. 2, 2023

(54) METHOD FOR CONNECTING IFE TO WIRELESS DEVICE

(71) Applicant: LG ELECTRONICS INC., Seoul (KR)

(72) Inventors: Jeonghwan KIM, Seoul (KR); Hangyu CHO, Seoul (KR); Hongwon LEE, Seoul (KR); Jingu CHOI, Seoul (KR)

(73) Assignee: LG ELECTRONICS INC., Seoul (KR)

(21) Appl. No.: 18/005,932

(22) PCT Filed: Jul. 20, 2020
(86) PCT No.: PCT/KR2020/009525

§ 371 Date: Jan. 18, 2023

(51) Int. Cl. H04W 76/10; H04W 48/10

(52) U.S. Cl. CPC H04W 76/10; H04W 48/10

(57) ABSTRACT

In a wireless communication system supporting Bluetooth communication, an in-flight entertainment (IFE) device may receive, from a first device, a signal including connectivity information of a second device. The IFE device may perform connection to the second device on the basis of the connectivity information.

### TECHNICAL FIELD

The present specification relates to a method for connecting an In Flight Entertainment (IFE) device to a Portable Electronic Device (PED) in a wireless communication system supporting Bluetooth communication.

### BACKGROUND

Bluetooth is one of the representative short-range wireless technologies for exchanging information by connecting various devices (smartphones, PCs, earphones, headphones, etc.) to each other. In addition, many people use it easily as a technology applied to most smartphones, PCs, laptops, etc., and the easy pairing procedure provides stable connectivity between devices. Recently developed LE technology can stably provide hundreds of kilobytes of information while consuming little power.

Bluetooth standard technology is divided into BR/EDR (Basic Rate/Enhanced Data Rate) and LE (Low Energy) core specifications.

Among them, Bluetooth Low Energy (hereinafter referred to as ‘BLE’) is a technology announced after Bluetooth Specification V4.

Since the BLE technology is designed to perform a connection procedure only when a data transmission request occurs between a master device and a slave device, it may not be suitable for real-time audio stream transmission where data transmission requests occur periodically.

That is, the BLE Master performs Connection in a short time when the Slave requests data transmission and reception, and performs Disconnection after exchanging necessary data within a relatively short time.

### SUMMARY

In a wireless communication system supporting Bluetooth communication according to various embodiments, an In Flight Entertainment (IFE) device may receive a signal including connection information of a second device from a first device. The IFE device may perform a connection with the second device based on the connection information.

According to an example of the present specification, it is possible to easily connect a portable electronic device (PED) and an in-flight entertainment (IFE) device in a situation where space is narrow and various devices are mixed, such as in an airplane. When a user tries to connect with a BR/EDR device in a space such as an airplane, all Inquiry Scan devices in the scan range are listed, but it is inconvenient for the user to check only with the Alias Name or BD ADDR of the device to be connected. In addition, when a user attempts to connect with a BLE device in a space such as an airplane, a notification is displayed on all devices around it through BLE Advertising. Therefore, in a narrow environment where many devices are mixed, notifications cause inconvenience to other users. According to an example of the present disclosure, since a terminal can provide connection information about a Bluetooth device to an IFE device, user's inconvenience can be solved. In addition, even when mirroring is performed, the mirroring operation can be performed directly without the need to find the user device in the IFE device.

### BRIEF DESCRIPTION OF THE DRAWINGS

FIG. 1 is a schematic diagram showing an example of a wireless communication system using Bluetooth low energy technology proposed in this specification.

FIG. 2 shows an example of an internal block diagram of a server device and a client device capable of implementing the methods proposed in this specification.

FIG. 3 shows an example of a Bluetooth low energy topology.

FIGS. 4 and 5 are diagrams illustrating an example of a Bluetooth communication architecture to which the methods proposed in this specification can be applied.

FIG. 6 is a flowchart illustrating an example of a method of providing an object transmission service in Bluetooth low energy technology.

FIG. 7 is a flowchart illustrating an embodiment of a connection method of a Bluetooth device supporting BR/EDR (basic rate/enhanced data rate).

FIG. 8 is a flowchart illustrating an embodiment of a method for connecting a Bluetooth device supporting Bluetooth Low Energy (BLE).

FIG. 9 is a flowchart illustrating an embodiment of a method for connecting a source device and a sync device supporting mirroring.

FIG. 10 is a diagram illustrating an embodiment of an IFE device attempting to connect with a BR/EDR device.

FIG. 11 is a diagram showing an example of a situation that occurs when a BLE device attempts to connect with an IFE device.

FIG. 12 is a diagram illustrating an example of a situation that occurs when an IFE device or a user terminal attempts to connect to an IFE device for mirroring.

FIG. 13 is a diagram illustrating an embodiment of a method of operating an IFE device.

FIG. 14 is a diagram illustrating an embodiment of a method of operating an IFE device.

FIG. 15 is a diagram illustrating an embodiment of a method of operating an IFE device.

FIGS. 16 to 18 are diagrams illustrating an embodiment of an IFE device operation.

FIG. 19 is a flowchart illustrating an embodiment of a method of operating an IFE device.

### DETAILED DESCRIPTION

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (control signal)”, it may denote that “control signal” is proposed as an example of the “control information”. In other words, the “control information” of the present specification is not limited to “control signal”, and “control signal” may be proposed as an example of the “control information”. In addition, when indicated as “control information (i.e., control signal)”, it may also mean that “control signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a Bluetooth communication system.

Hereinafter, in order to describe a technical feature of the present specification, a technical feature applicable to the present specification will be described.

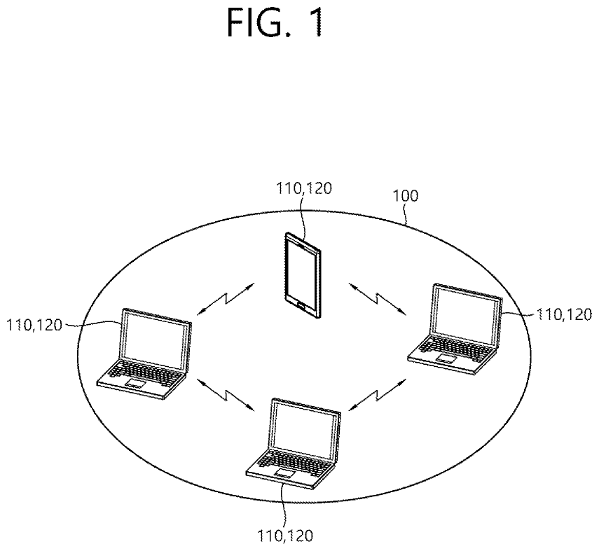

FIG. 1 is a schematic diagram showing an example of a wireless communication system using Bluetooth low energy technology proposed in this specification.

The wireless communication system 100 includes at least one server device (Server Device, 110) and at least one client device (Client Device, 120).

The server device and the client device perform Bluetooth communication using Bluetooth Low Energy (BLE, hereinafter referred to as ‘BLE’ for convenience) technology.

First, compared to Bluetooth BR/EDR (Basic Rate/Enhanced Data Rate) technology, BLE technology has a relatively small duty cycle, enables low-cost production, and can significantly reduce power consumption through low-speed data transmission rates. If a coin cell battery is used, it can operate for more than one year.

In addition, the BLE technology simplifies the connection procedure between devices, and the packet size is designed to be smaller than that of Bluetooth BR/EDR technology.

In BLE technology, (1) the number of RF channels is 40, (2) the data transmission rate supports 1 Mbps, (3) the topology is a star structure, (4) the latency is 3 ms, and (5) the maximum current is It is less than 15 mA, (6) output power is less than 10 mW (10 dBm), and (7) is mainly used for applications such as mobile phones, watches, sports, health care, sensors, and device control.

The server device 110 may operate as a client device in relation to other devices, and the client device may operate as a server device in relation to other devices. That is, in the BLE communication system, any one device can operate as a server device or a client device, and, if necessary, it is also possible to simultaneously operate as a server device and a client device.

The server device 110 can be expressed as a data service device, a master device, a master, a server, a conductor, a host device, an audio source device, a first device, etc. The client device may be expressed as a slave device, a slave, a client, a member, a sink device, an audio sink device, a second device, and the like.

The server device and the client device correspond to the main components of the wireless communication system, and the wireless communication system may include other components in addition to the server device and the client device.

The server device refers to a device that receives data from a client and directly communicates with the client device to provide data to the client device through a response when receiving a data request from the client device.

In addition, the server device sends a notification message and an indication message to the client device to provide data information to the client device. In addition, when transmitting the instruction message to the client device, the server device receives a confirmation message corresponding to the instruction message from the client.

In addition, the server device can provide data information to the user through a display unit or receive a request input from the user through a user input interface in the process of transmitting and receiving notification, instruction, and confirmation messages with the client device.

In addition, the server device may read data from a memory unit or write new data to a corresponding memory unit in the course of transmitting and receiving a message with the client device.

In addition, one server device can be connected to a plurality of client devices, and can be easily reconnected (or connected) with client devices by utilizing bonding information.

The client device 120 refers to a device that requests data information and data transmission from a server device.

The client device receives data from the server device through a notification message, an instruction message, and the like, and when receiving the instruction message from the server device, sends a confirmation message in response to the instruction message.

Similarly, the client device may provide information to a user through an output unit or receive input from a user through an input unit in the process of transmitting and receiving messages with the server device.

In addition, the client device may read data from a memory or write new data to a corresponding memory while transmitting and receiving a message with the server device.

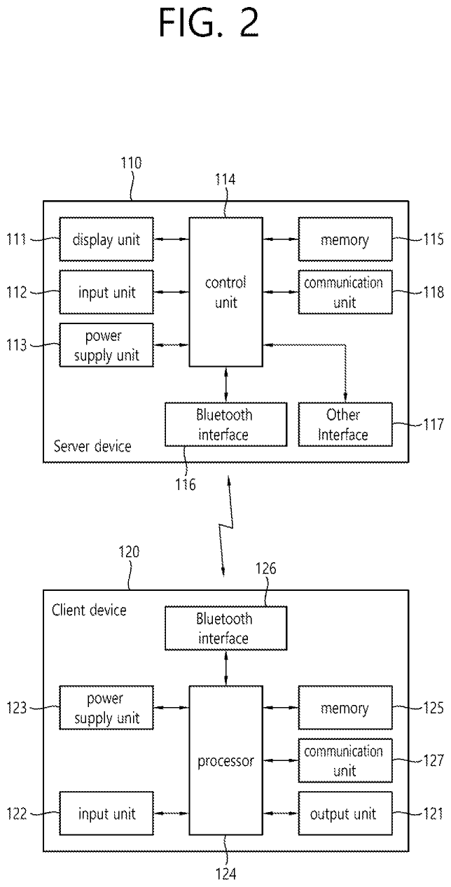

Hardware components such as an output unit, an input unit, and a memory of the server device and the client device will be described in detail with reference to FIG. 2.

In addition, the wireless communication system may configure Personal Area Networking (PAN) through Bluetooth technology. For example, in the wireless communication system, files and documents can be exchanged quickly and safely by establishing a private piconet between devices.

A BLE device (or appliance) may be operable to support various Bluetooth-related protocols, profiles, processes, and the like.

FIG. 2 shows an example of an internal block diagram of a server device and a client device capable of implementing the methods proposed in this specification.

A server device may be connected with at least one client device.

In addition, if necessary, the block diagram of each device may further include other components (modules, blocks, units), and some of the components shown in FIG. 2 may be omitted.

As shown in FIG. 2, the server device includes a display unit 111, an input unit 112, a power supply unit 113, a processor 114, and a memory unit 115, a Bluetooth interface 116, another Interface 117, and a communication unit (or transceiver, 118).

The output unit 111, the input unit 112, the power supply unit 113, the processor 114, the memory 115, the Bluetooth interface 116, the other communication interface 117 and the communication unit 118 are functionally connected to perform the method proposed in this specification.

In addition, the client device includes an output unit (Display Unit, 121), an input unit (User Input Interface, 122), a power supply unit, 123, a processor, 124, a memory (Memory Unit, 125), and a Bluetooth interface, 126 and a communication unit (or transceiver, 127).

The output unit 121, the input unit 122, the power supply unit 123, the processor 124, the memory 125, the Bluetooth interface 126, and the communication unit 127 are functionally connected to perform the method proposed in this specification.

The Bluetooth interfaces 116 and 126 refer to units (or modules) capable of transmitting requests/responses, commands, notifications, instruction/confirmation messages, etc., or data between devices using Bluetooth technology.

The memories 115 and 125 are units implemented in various types of devices and refer to units in which various types of data are stored.

The processors 114 and 124 refer to modules that control the overall operation of a server device or a client device, and control to request transmission of messages through a Bluetooth interface and other communication interfaces, and to process received messages.

The processors 114 and 124 may be expressed as a controller, a control unit, or a controller.

The processors 114 and 124 may include application-specific integrated circuits (ASICs), other chipsets, logic circuits, and/or data processing devices.

The memories 115 and 125 may include read-only memory (ROM), random access memory (RAM), flash memory, memory cards, storage media, and/or other storage devices.

The communication units 118 and 127 may include baseband circuits for processing radio signals. When the embodiment is implemented as software, the above-described technique may be implemented as a module (process, function, etc.) that performs the above-described functions. A module can be stored in memory and executed by a processor.

The memories 115 and 125 may be internal or external to the processors 114 and 124 and may be connected to the processors 114 and 124 by various well-known means.

The output units 111 and 121 refer to modules for providing device status information and message exchange information to the user through a screen.

The power supply unit (power supply units 113 and 123) refers to a module that receives external power and internal power under the control of a control unit and supplies power required for operation of each component.

As seen above, BLE technology has a small duty cycle and can greatly reduce power consumption through low data rates. The power supply unit can supply power necessary for the operation of each component even with a small output power (less than 10 mW (10 dBm)).

The input units 112 and 122 refer to modules that allow the user to control the operation of the device by providing a user's input to the control unit, such as a screen button.

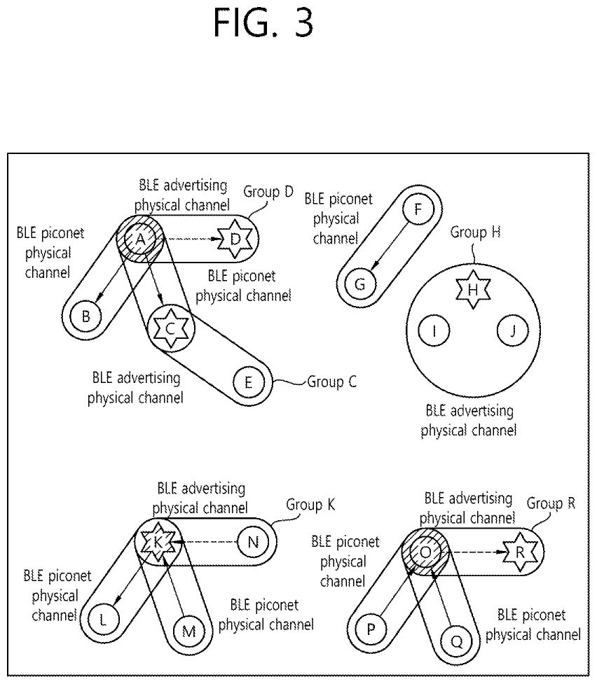

FIG. 3 shows an example of a Bluetooth low energy topology.

Referring to FIG. 3, device A corresponds to a master in a piconet (piconet A, shaded area) having device B and device C as slaves.

Here, a piconet refers to a set of devices occupying a shared physical channel in which one of a plurality of devices is a master and the other devices are connected to the master device.

A BLE slave does not share a common physical channel with the master. Each slave communicates with the master through a separate physical channel. There is another piconet (piconet F) with a master device F and a slave device G.

Device K is on scatternet K. Here, a scatternet refers to a group of piconets in which connections between other piconets exist.

Device K is the master of device L and the slave of device M.

Device O is also on scatternet O. Device O is both a slave of device P and a slave of device Q.

As shown in FIG. 3, there are five different device groups.

Device D is the advertiser and device A is the initiator. (Group D)

Device E is a scanner, and device C is an advertiser (group C).

Device H is an advertiser and devices I and J are scanners. (Group H)

Device K is also an advertiser, and device N is an initiator. (Group K)

Device R is the advertiser and device O is the initiator. (Group R)

Devices A and B use one BLE piconet physical channel.

Devices A and C use another BLE piconet physical channel.

In group D, device D advertises using an advertising event connectable on an advertising physical channel, and device A is the initiator. Device A can form a connection with device D and add the device to piconet A.

In group C, device C advertises on the advertising physical channel using some type of advertising event captured by scanner device E.

Group D and group C may use different advertising physical channels or use different times to avoid collisions.

Piconet F has one physical channel. Devices F and G use one BLE piconet physical channel. Device F is the master and device G is the slave.

Group H has one physical channel. Devices H, I and J use one BLE advertising physical channel. Device H is an advertiser and devices I and J are scanners.

In scatternet K, devices K and L use one BLE piconet physical channel. Devices K and M use another BLE piconet physical channel.

In group K, device K advertises using an advertising event connectable on the advertising physical channel, and device N is the initiator. Device N can form a connection with device K. Here, device K becomes a slave of two devices and a master of one device at the same time.

In Scatternet O, devices O and P use one BLE piconet physical channel. Devices O and Q use another BLE piconet physical channel.

In group R, device R advertises using an advertising event connectable on the advertising physical channel, and device O is the initiator. Device O can form a connection with device R. Here, device O becomes a slave of two devices and a master of one device at the same time.

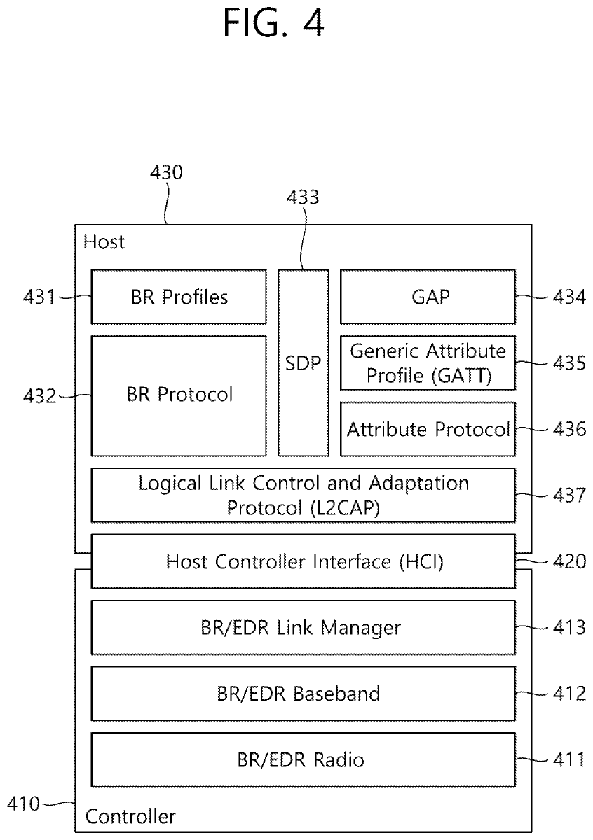

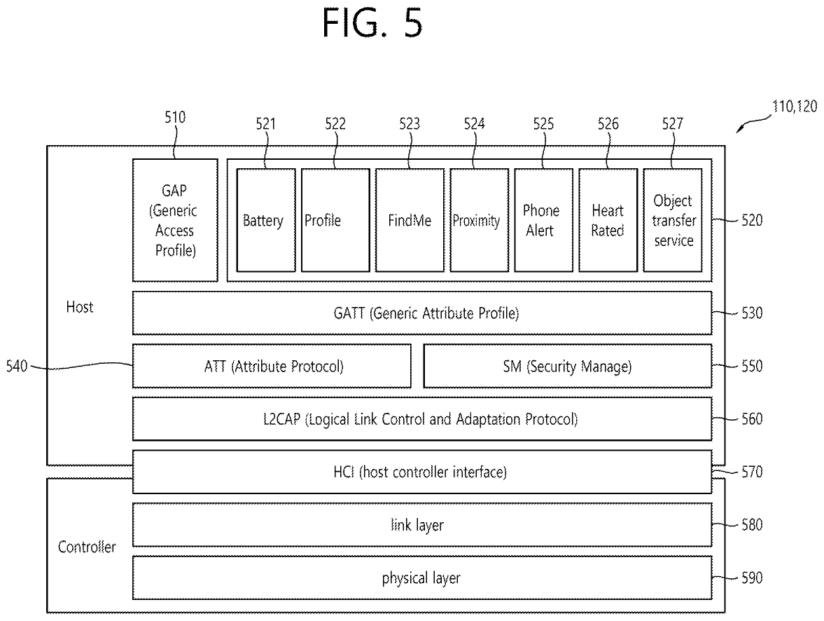

FIGS. 4 and 5 are diagrams illustrating an example of a Bluetooth communication architecture to which the methods proposed in this specification can be applied.

Specifically, FIG. 4 illustrates an example of a Bluetooth Basic Rate (BR)/Enhanced Data Rate (EDR) architecture, and FIG. 5 illustrates an example of a Bluetooth Low Energy (LE) architecture.

First, as shown in FIG. 4, the Bluetooth BR/EDR architecture includes a controller stack (Controller stACK) 410, a Host Controller Interface (HCI) 420, and a host stack (Host stACK) 430.

The controller stack (or controller module 410) refers to a wireless transmission/reception module that receives a 2.4 GHz Bluetooth signal and hardware for transmitting or receiving Bluetooth packets, and includes a BR/EDR Radio layer 411 and a BR/EDR baseband layer 412), and a BR/EDR Link Manager layer 413.

The BR/EDR Radio layer 411 is a layer that transmits and receives 2.4 GHz radio signals, and can transmit data by hopping 79 RF channels when Gaussian Frequency Shift Keying (GFSK) modulation is used.

The BR/EDR=Baseband layer 412 is responsible for transmitting a digital signal, selects a channel sequence hopping 1600 times per second, and transmits a time slot with a length of 625 us for each channel.

The Link Manager layer 413 utilizes Link Manager Protocol (LMP) to control overall operations (link setup, control, and security) of a Bluetooth connection.

The Link Manager layer may perform the following functions.
ACL/SCO logical transport and logical link setup and control.
Detach: Aborts the connection and notifies the other device of the reason for the abort.
Power control and role switch.
Performs security (authentication, pairing, encryption) functions.

The Host Controller Interface layer 420 provides an interface between the host module 430 and the controller module 410 so that the host can provide commands and data to the controller, and the controller can provide events and data to the host.

The host stack (or host module 430) includes L2CAP (437), SDP (Service Discovery Protocol, 433), BR/EDR Protocol (432), BR/EDR Profiles (431), Attribute Protocol (436), Generic Access Profile (GAP,434) and Generic Attribute Profile (GATT,435).

The Logical Link Control and Adaptation Protocol (L2CAP, 437) provides one bidirectional channel for transmitting data to a specific protocol or profile.

The L2CAP multiplexes various protocols and profiles provided by Bluetooth.

L2CAP of Bluetooth BR/EDR uses dynamic channel, supports protocol service multiplexer, retransmission, and streaming mode, and provides segmentation and reassembly, per-channel flow control, and error control.

The Service Discovery Protocol (SDP) 433 refers to a protocol for finding services (profiles and protocols) supported by a Bluetooth device.

The BR/EDR Protocol and Profiles 432 and 431 define a service (profile) using Bluetooth BR/EDR and an application protocol for exchanging these data.

The Attribute Protocol 436 is a Server-Client structure and defines rules for accessing data of a counterpart device. There are 6 message types (Request message, Response message, Command message, Notification message, Indication message) as shown below.
Request message from client to server with Response message from server to client
Command message from client to server without Response message
Notification message from server to client without Confirm message
Indication message from server to client with Confirm message from client to server

The Generic Attribute Profile (GATT, 435) defines the type of attribute.

The Generic Access Profile (GAP, 434) defines device discovery, connection, and methods of providing information to users, and provides privacy.

As shown in FIG. 5, the BLE architecture includes a controller stack (Controller stACK) operable to process a radio interface where timing is critical and a host stack (Host stACK) operable to process high level data.

The controller stACK may be called a controller, but in order to avoid confusion with the processor, which is an internal component of the device previously mentioned in FIG. 2, it will be expressed as a controller stACK below.

First, the controller stack may be implemented using a communication module that may include a Bluetooth radio and a processor module that may include a processing device such as, for example, a microprocessor.

The host stack may be implemented as part of the OS running on the processor module or as an instantiation of a package (pACKage) on the OS.

In some instances, a controller stack and a host stack may operate or run on the same processing device within a processor module.

The host stack includes GAP (Generic Access Profile, 510), GATT based Profiles (520), GATT (Generic Attribute Profile, 530), ATT (Attribute Protocol, 540), SM (Security Manage, 550), L2CAP (Logical Link Control and Adaptation Protocol, 560). However, the host stack is not limited thereto and may include various protocols and profiles.

The host stack uses L2CAP to multiplex various protocols and profiles provided by Bluetooth.

First, L2CAP (Logical Link Control and Adaptation Protocol, 560) provides one bidirectional channel for transmitting data to a specific protocol or profile.

L2CAP may be operable to multiplex data between higher layer protocols, segment and reassemble packages, and manage multicast data transmission.

BLE uses three fixed channels (one for signaling CH, one for Security Manager, and one for Attribute protocol).

On the other hand, BR/EDR (Basic Rate/Enhanced Data Rate) uses a dynamic channel and supports protocol service multiplexer, retransmission, streaming mode, and the like.

Security Manager (SM) 550 is a protocol for authenticating devices and providing key distribution.

ATT (Attribute Protocol, 540) defines rules for accessing data of a counterpart device in a server-client structure. There are 6 message types (Request, Response, Command, Notification, Indication, Confirmation) in ATT.

That is, \textcircled{1} Request and Response message: The Request message is a message for requesting specific information from the client device to the server device, and the Response message is a response message to the Request message and refers to a message transmitted from the server device to the client device.

\textcircled{2} Command message: This is a message transmitted from the client device to the server device to instruct a specific operation command. The server device does not transmit a response to the command message to the client device.

\textcircled{3} Notification message: This is a message sent from the server device to the client device to notify such as an event. The client device does not transmit a confirmation message for the notification message to the server device.

\textcircled{4} Indication and Confirm message: This is a message sent from the server device to the client device to notify such as an event. Unlike the notification message, the client device transmits a confirmation message for the indication message to the server device.

GAP (Generic Access Profile) is a newly implemented layer for BLE technology, and is used to control role selection and multi-profile operation for communication between BLE devices.

In addition, GAP is mainly used for device discovery, connection creation, and security procedures, defines a method of providing information to users, and defines the following attribute types.

\textcircled{1} Service: Defines the basic operation of the device as a combination of behaviors related to data

\textcircled{2} Include: Defines the relationship between services

\textcircled{3} Characteristics: Data values used in the service

\textcircled{4} Behavior: Computer-readable format defined as UUID (Universal Unique Identifier, value type)

GATT-based Profiles are profiles that depend on GATT and are mainly applied to BLE devices. GATT-based Profiles may be Battery, Time, FindMe, Proximity, Time, Object Delivery Service, etc. Details of GATT-based Profiles are as follows.

Battery: How to exchange battery information

Time: How to exchange time information

FindMe: Provides alarm service according to distance

Proximity: how to exchange battery information

Time: How to exchange time information

GATT may be operable as a protocol that describes how ATT is used in the configuration of services. For example, GATT may be operable to specify how ATT attributes are grouped together into services, and may be operable to describe characteristics associated with services.

Thus, GATT and ATT can use features to describe the status and services of a device, how they relate to each other and how they are used.

The controller stack includes a physical layer (590), a link layer (580), and a host controller interface (570).

The physical layer (wireless transmission/reception module, 590) is a layer that transmits and receives 2.4 GHz radio signals and uses GFSK (Gaussian Frequency Shift Keying) modulation and a frequency hopping technique consisting of 40 RF channels.

Link layer 580 transmits or receives Bluetooth packets.

In addition, the link layer creates a connection between devices after performing advertising and scanning functions using 3 advertising channels, and provides a function of exchanging data packets of up to 42 bytes through 37 data channels.

HCI (Host Controller Interface) provides an interface between the host stack and the controller stack, allowing the host stack to provide commands and data to the controller stack, and the controller stack to provide events and data to the host stack.

Hereinafter, procedures of Bluetooth Low Energy (BLE) technology will be briefly reviewed.

The BLE procedure may be divided into a device filtering procedure, an advertising procedure, a scanning procedure, a discovering procedure, and a connecting procedure.

Device Filtering Procedure

The device filtering procedure is a method for reducing the number of devices performing responses to requests, instructions, notifications, etc. in the controller stack.

When a request is received by all devices, since it is not necessary to respond to it, the controller stack can control the BLE controller stack to reduce power consumption by reducing the number of requests sent.

An advertising device or a scanning device may perform the above device filtering procedure to restrict devices receiving advertising packets, scan requests, or connection requests.

Here, the advertisement device refers to a device that transmits an advertisement event, that is, performs an advertisement, and is also referred to as an advertiser.

A scanning device refers to a device that performs scanning and a device that transmits a scan request.

In BLE, when a scanning device receives some advertising packets from an advertising device, the scanning device should send a scan request to the advertising device.

However, when the device filtering procedure is used and transmission of the scan request is unnecessary, the scanning device may ignore advertisement packets transmitted from the advertisement device.

A device filtering procedure may also be used in the connection request process. If device filtering is used in the connection request process, it is not necessary to transmit a response to the connection request by ignoring the connection request.

Advertising Procedure

The advertising device performs an advertising procedure to perform non-directional broadcasting to devices within the area.

Here, non-directional broadcast refers to broadcast in all (all) directions rather than broadcast in a specific direction.

In contrast, directional broadcast refers to broadcasting in a specific direction. Non-directional broadcasting occurs between an advertising device and a device in a listening (or listening) state (hereinafter referred to as a listening device) without a connection procedure.

The advertising procedure is used to establish a Bluetooth connection with a nearby initiating device.

Alternatively, the advertising procedure may be used to provide periodic broadcast of user data to scanning devices that are listening on the advertising channel.

In the advertisement process, all advertisements (or advertisement events) are broadcast through advertisement physical channels.

Advertising devices may receive scan requests from listening devices that are listening to obtain additional user data from the advertising device. The advertising device transmits a response to the scan request to the device that sent the scan request through the same advertising physical channel as the advertising physical channel that received the scan request.

Broadcast user data sent as part of advertisement packets is dynamic data, whereas scan response data is generally static data.

An advertising device may receive a connection request from an initiating device on an advertising (broadcast) physical channel. If the advertising device uses a connectable advertising event and the initiating device is not filtered by the device filtering procedure, the advertising device stops advertising and enters a connected mode. The advertising device may start advertising again after the connection mode.

Scanning Procedure

A device that performs scanning, that is, a scanning device performs a scanning procedure to listen to a non-directional broadcast of user data from advertising devices using an advertising physical channel.

The scanning device transmits a scan request to the advertising device through an advertising physical channel to request additional user data from the advertising device. The advertising device transmits a scan response, which is a response to the scan request, including additional user data requested by the scanning device through the advertising physical channel.

The scanning procedure may be used while being connected to another BLE device in a BLE piconet.

If the scanning device receives a broadcast advertising event and is in an initiator mode capable of initiating a connection request, the scanning device transmits a connection request to the advertising device through the advertising physical channel, thereby and start a Bluetooth connection.

When the scanning device sends a connection request to the advertising device, the scanning device stops initiator mode scanning for additional broadcasting and enters a connection mode.

Discovering Procedure

Devices capable of Bluetooth communication (hereinafter referred to as ‘Bluetooth devices’) perform advertising and scanning procedures to discover nearby devices or to be discovered by other devices within a given area.

The discovery procedure is performed asymmetrically. A Bluetooth device trying to find other devices around it is called a discovering device, and it listens to find for devices advertising scannable advertising events. A Bluetooth device discovered and available from other devices is called a discoverable device, and actively broadcasts an advertisement event through an advertisement (broadcast) physical channel so that other devices can scan it.

Both the discovering device and the discoverable device may already be connected to other Bluetooth devices in the piconet.

Connecting Procedure

The connection procedure is asymmetric, and the connection procedure requires that another Bluetooth device perform a scanning procedure while a specific Bluetooth device performs an advertising procedure.

That is, the advertisement process can be targeted, so that only one device will respond to the advertisement. After receiving an accessible advertising event from the advertising device, connection may be initiated by transmitting a connection request to the advertising device through an advertising (broadcast) physical channel.

Next, operation states in the BLE technology, that is, an advertising state, a scanning state, an initiating state, and a connection state will be briefly reviewed.

Advertising State

The Link Layer (LL) enters the advertised state, at the direction of the host (stack). When the link layer is in the advertising state, the link layer transmits advertising packet data units (PDUs) in advertising events.

Each advertising event consists of at least one advertising PDU, and the advertising PDUs are transmitted through the used advertising channel indices. The advertising event may be terminated when the advertising PDU is transmitted through each of the advertising channel indexes used, or the advertising event may be terminated earlier if the advertising device needs to secure space for performing other functions.

Scanning State

The link layer enters the scanning state at the direction of the host (stack). In the scanning state, the link layer listens for advertising channel indices.

There are two types of scanning states: passive scanning and active scanning, and each scanning type is determined by the host.

A separate time or advertising channel index for performing scanning is not defined.

During the scanning state, the link layer listens for an advertising channel index during the scanWindow duration. The scanInterval is defined as the interval (interval) between the starting points of two consecutive scan windows.

The link layer should listen for completion of all scan intervals in the scan window, as directed by the host, if there are no scheduling conflicts. In each scan window, the link layer has to scan different advertising channel indices. The link layer uses all available advertising channel indices.

When passive scanning, the link layer only receives packets and does not transmit any packets.

When active scanning, the link layer performs listening to rely on the Advertising PDU type to be able to request Advertising PDUs from the Advertising Device and additional information related to the Advertising Device.

Initiating State

The link layer enters the initiation state at the direction of the host (stack).

When the link layer is in the initiating state, the link layer listens for advertising channel indices.

During the initiation state, the link layer listens to the advertising channel index during the scan window period.

Connection State

The link layer enters the connected state when the device making the connection request, that is, when the initiating device sends a CONNECT_REQ PDU to the advertising device or when the advertising device receives a CONNECT_REQ PDU from the initiating device.

After entering the connected state, the connection is considered to be created. However, it need not be considered to be established at the time when the connection enters the connected state. The only difference between a newly created connection and an established connection is the link layer connection supervision timeout value.

When two devices are connected, they act in different roles.

A link layer performing a master role is called a master, and a link layer performing a slave role is called a slave. The master controls the timing of the connection event, and the connection event refers to the timing of synchronization between the master and the slave.

Hereinafter, packets defined in the Bluetooth interface will be briefly reviewed. BLE devices use packets defined below.

Packet Format

The Link Layer has only one packet format used for both Advertising Channel Packets and Data Channel Packets.

Each packet consists of four fields: Preamble, Access Address, PDU, and CRC.

When one packet is transmitted on an advertising physical channel, the PDU will be an advertising channel PDU, and when one packet is transmitted on a data physical channel, the PDU will be a data channel PDU.

Advertising Channel PDU (Advertising Channel PDU)

An advertising channel PDU (PACKet Data Unit) has a 16-bit header and payloads of various sizes.

The PDU type field of the advertising channel PDU included in the header indicates the PDU type as defined in Table 1 below.

TABLE 1

| PDU Type | PACKet Name |
|---|---|
| 0000 | ADV-IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The advertising channel PDU types below are referred to as advertising PDUs and are used in specific events.

ADV_IND: chainable non-directional advertising event

ADV_DIRECT_IND: directive advertising events that can be chained

ADV_NONCONN_IND: non-connectable non-direction advertising event

ADV_SCAN_IND: scannable non-directional ad event

The PDUs are transmitted in the link layer in an advertising state and received by the link layer in a scanning state or initiating state.

Scanning PDUs

The advertising channel PDU type below is called a scanning PDU and is used in the conditions described below.

SCAN_REQ: Sent by the link layer in the scanning state and received by the link layer in the advertising state.

SCAN_RSP: Sent by the link layer in the advertising state and received by the link layer in the scanning state.

Initiating PDUs

The advertising channel PDU type below is called an initiation PDU.

CONNECT_REQ: Sent by the link layer in the initiating state and received by the link layer in the advertising state.

Data Channel PDUs

A data channel PDU has a 16-bit header, payloads of various sizes, and may include a Message Integrity Check (MIC) field.

As discussed above, the procedures, states, packet formats, etc. in BLE technology can be applied to perform the methods proposed in this specification.

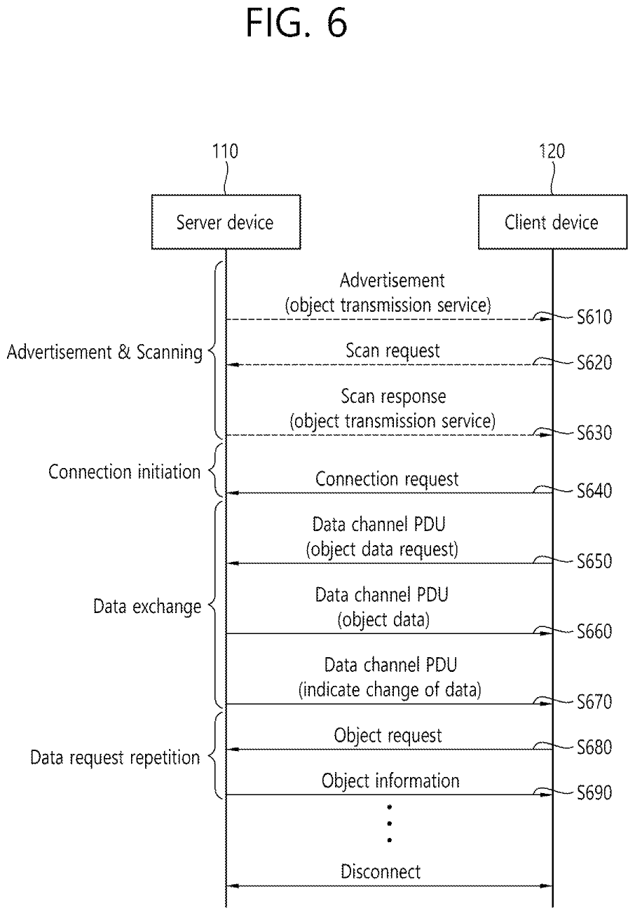

FIG. 6 is a flowchart illustrating an example of a method of providing an object transmission service in Bluetooth low energy technology.

Object Delivery Service or Object Transfer Service refers to a service supported by BLE to transmit or receive objects or data such as bulk data in Bluetooth communication.

An advertisement process and a scanning process corresponding to steps S610 to S630 are performed to establish a Bluetooth connection between the server device and the client device.

First, the server device transmits an advertisement message to the client device to notify information related to the server device including the object transmission service (S610).

The advertisement message may be expressed as an advertisement packet data unit (PDU), advertisement packet, advertisement, advertisement frame, advertisement physical channel PDU, and the like.

The advertisement message may include service information provided by the server device (including service name), the name of the server device, manufacturer data, and the like.

Also, the advertisement message may be transmitted to the client device in a broadcast method or a unicast method.

Thereafter, the client device transmits a scan request message to the server device in order to obtain more detailed information related to the server device (S620).

The scan request message may be expressed as a scanning PDU, a scan request PDU, a scan request, a scan request frame, or a scan request packet.

Thereafter, the server device transmits a scan response message to the client device in response to the scan request message received from the client device (S630).

The scan response message includes server device related information requested by the client device. Here, the server device-related information may be an object or data transmittable by the server device in relation to providing an object transmission service.

When the advertisement process and the scanning process end, the server device and the client device perform a connection initiating process and a data exchange process corresponding to steps S640 to S670.

Specifically, the client device transmits a Connect Request message to the server device for a Bluetooth communication connection with the server device (S640).

The connection request message may be expressed as a connection request PDU, an initiation PDU, a connection request frame, or a connection request.

Through step S640, a Bluetooth connection is established between the server device and the client device, and then the server device and the client device exchange data. During the data exchange process, data may be transmitted and received through a data channel PDU.

The client device transmits an object data request to the server device through a data channel PDU (S650). The data channel PDU may be expressed as a data request message or data request frame.

Then, the server device transmits the object data requested by the client device to the client device through a data channel PDU (S660).

Here, the data channel PDU is used to provide data or request data information to a counterpart device in a manner defined in the Attribute protocol.

Thereafter, when data change occurs in the server device, the server device transmits data change indication information through a data channel PDU to the client device to inform the change of data or object (S670).

Then, the client device requests changed object information to the server device to find the changed data or changed object (S680).

Thereafter, the server device transmits object information changed in the server device to the client device in response to the changed object information request (S690).

Thereafter, the client device finds a changed object through a comparative analysis of the received changed object information and object information currently possessed by the client device.

However, the client device repeatedly performs steps S680 to S690 until the changed object or data is found.

Thereafter, when the connection state between the host device and the client device does not need to be maintained, the host device or the client device may disconnect the corresponding connection state.

When you board a plane to go on a business trip or a trip, you can use IFE (In Flight Entertainment) located in front of your seat during flight time. Flight attendants distribute earphones. For various reasons, there are many cases where you want to use PED (Portable Electronic Device), but it is not possible in the current system.

Hereinafter, a UX (User Experience) that can easily use PED (Portable Electronic Device) in IFE (In Flight Entertainment) is proposed.

To perform wireless communication between two devices using Bluetooth communication, a user must search for a target device to communicate with and perform a procedure for requesting a connection. To connect the IFE and PED, the user must enter the PED into pairing mode and make the PED discoverable.

The method of entering Pairing Mode (Discoverable) can be different for each PED that supports Bluetooth, and the user has to read the manual to check how to enter Pairing Mode, which is inconvenient. After that, the user must directly select and connect the Discoverable device. If there are many discovered devices, it may be difficult for the user to determine which Target Device (i.e., the PED the user is trying to connect to) is.

In particular, in a mixed and complex environment with many narrow devices, notifications are sent to all nearby source displays when advertising is performed, but it is difficult for users to distinguish the target device as in the previous technology.

In order to solve this problem, a method for easy Bluetooth search and connection is proposed below.

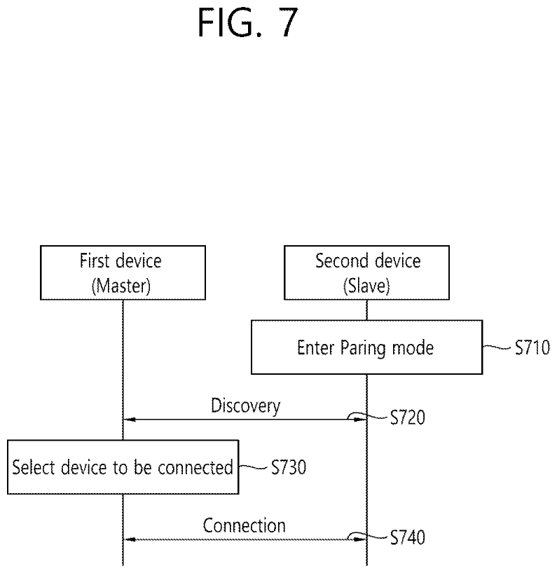

FIG. 7 is a flowchart illustrating an embodiment of a connection method of a Bluetooth device supporting BR/EDR (basic rate/enhanced data rate).

Referring to FIG. 7, a first device and a second device may perform a Bluetooth connection. For example, the first device may be a master device, and the second device may be a slave device. For example, the first device may be a smart phone, and the second device may be a PED (e.g., Bluetooth headset, Bluetooth earphone, etc.).

In order for the first device and the second device to be connected, user intervention may be required three times. For example, the user may enter the second device into a pairing mode and initiate a discovery procedure of the first device. Thereafter, the user may select a device (i.e., a second device) to be connected from the first device after completing the discovery procedure. When there are many devices around, since there are many options to be selected, it may be difficult for the user to discern which device to connect (i.e., which device is the second device).

The second device may enter Paring Mode (S710).

The first device and the second device may perform a discovery procedure (S720). For example, the first device may transmit a search signal, and the second device receiving the search signal may transmit a search response signal.

The first device may select a device to be connected (S730). For example, the first device may receive a search response signal from the second device and select a device (e.g., the second device) to connect based on the search response signal.

The first device and the second device may be connected (S740). For example, the first device may transmit a connection signal to the second device, and the second device may transmit a connection response signal to the first device.

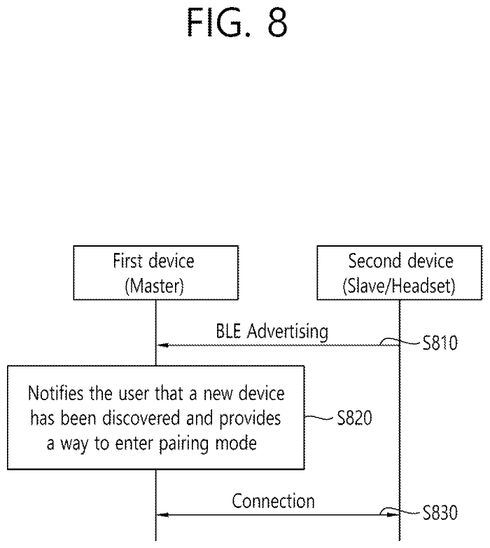

FIG. 8 is a flowchart illustrating an embodiment of a method for connecting a Bluetooth device supporting Bluetooth Low Energy (BLE).

Referring to FIG. 8, a first device and a second device may perform a Bluetooth connection. The first device and the second device may perform a Bluetooth connection. For example, the first device may be a master device, and the second device may be a slave device. For example, the first device may be a smart phone, and the second device may be a PED (e.g., Bluetooth headset, Bluetooth earphone, etc.).

The second device may transmit a BLE Advertising signal (S810). The BLE Advertising signal may be transmitted in a broadcasting method. That is, the BLE Advertising signal can be transmitted to all nearby devices. For example, when a case of a wireless earphone is opened, a BLE Advertising signal may be transmitted.

The first device may receive a BLE Advertising signal from the second device. The first device may transmit information that a new device has been discovered to the user (S820). For example, the first device may show information that a new device (i.e., the second device) has been discovered on the display. For example, the first device may transmit information related to whether to perform pairing with a new device to the user (S820). For example, the first device may show information related to whether to perform pairing with a new device on the display.

When obtaining information related to pairing with the second device from the user, the first device may perform a connection with the second device (S830). For example, the first device may transmit a connection signal to the second device, and the second device may transmit a connection response signal to the first device.

Recently, headsets that support easy connection to users using BLE Advertising are increasing. Airpods are a typical example. When you open the case of Airpods, BLE Advertising starts and a notification that new Airpods are detected appears on all devices that receive it.

At this time, if you press the Pairing Button, a new device is connected. It is convenient to use with an easy UX.

However, it may not be appropriate in an environment with many devices around, such as IFE. This is because a notification pops up on all devices that receive BLE Adverting, and due to the nature of IFE, a notification pops up on all devices around it in a dense space, making it difficult to find a device to connect to and the notification can cause inconvenience to other devices.

Hereinafter, a method for Bluetooth search and connection in an environment where space is narrow and many devices are mixed, such as an airplane, is proposed.

The problems of Bluetooth connection of PED devices in a narrow environment such as an airplane where many devices are mixed are as follows.

BR/EDR device: All Inquiry Scan devices in the scan range of IFE devices are listed, but it can cause inconvenience to the user as it needs to be checked only with the alias name or BD ADDR (Bluetooth Device address) of the device to be connected.

BLE device: Notifications can appear on all nearby IFE devices through BLE Adverting, so notifications can cause inconvenience to other users in a narrow environment where many devices are mixed.

It is very inconvenient and difficult for a user to directly select a device to connect to in an environment where many devices are mixed, such as on an airplane. Therefore, user experience that can be easily known and used is necessary.

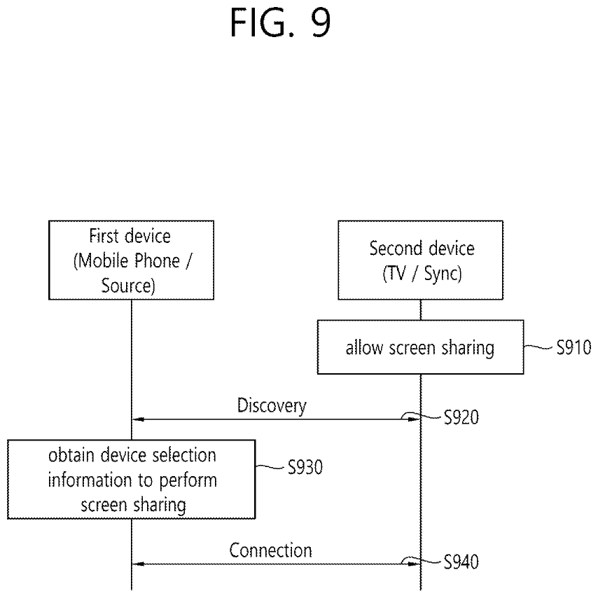

FIG. 9 is a flowchart illustrating an embodiment of a method for connecting a source device and a sync device supporting mirroring.

Referring to FIG. 9, the first device and the second device may perform mirroring (e.g., screen share, screen mirroring). The first device and the second device may perform a mirroring connection. For example, the first device can be a smartphone or source device, and the second device can be a TV or sink device. For example, the second device may bring and display the screen of the first device as it is.

The second device may allow screen sharing (S910). For example, the user can allow screen sharing of the second device. For example, the second device may obtain information related to screen sharing permission from the user.

The first device may perform discovery on a second device to perform mirroring (S920). For example, the first device may exchange a discovery signal with the second device. For example, a first device may transmit a discovery signal to a second device and receive a discovery response signal from the second device.

The first device may obtain selection information related to a device to perform screen sharing from the user (S930). For example, the first device may expose information indicating that it can perform mirroring (i.e., screen share) with the searched second device on the display, and the user may select the second device. The first device may obtain selection information related to the second device.

The first device may perform a connection with the second device (S940).

It may be difficult for a user to select a device in front of the user to use mirroring in an airplane environment. For example, when a search is performed to perform mirroring, since many devices are searched, it may be difficult to determine which display the user wants to use.

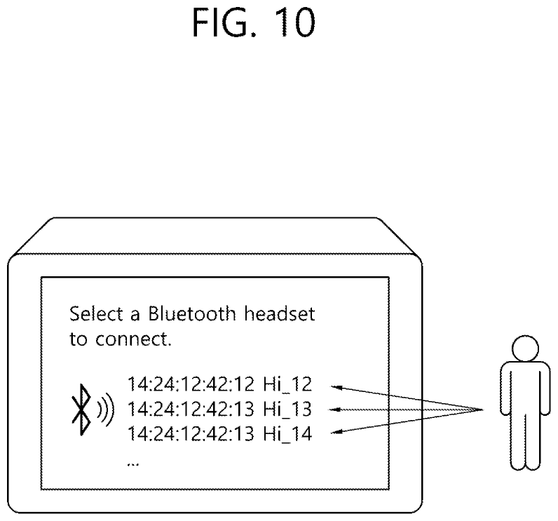

FIG. 10 is a diagram illustrating an embodiment of an IFE device attempting to connect with a BR/EDR device.

Referring to FIG. 10, the IFE device may perform a search for a Bluetooth device to connect with a BR/EDR device. For example, the IFE device may transmit a Bluetooth discovery signal. Several Bluetooth devices may be searched for in an environment such as inside an airplane in which several Bluetooth devices (e.g., BR/EDR devices) are mixed around. It may be difficult for the user to find his/her own Bluetooth device (i.e., BR/EDR device) among several Bluetooth devices found in the IFE device.

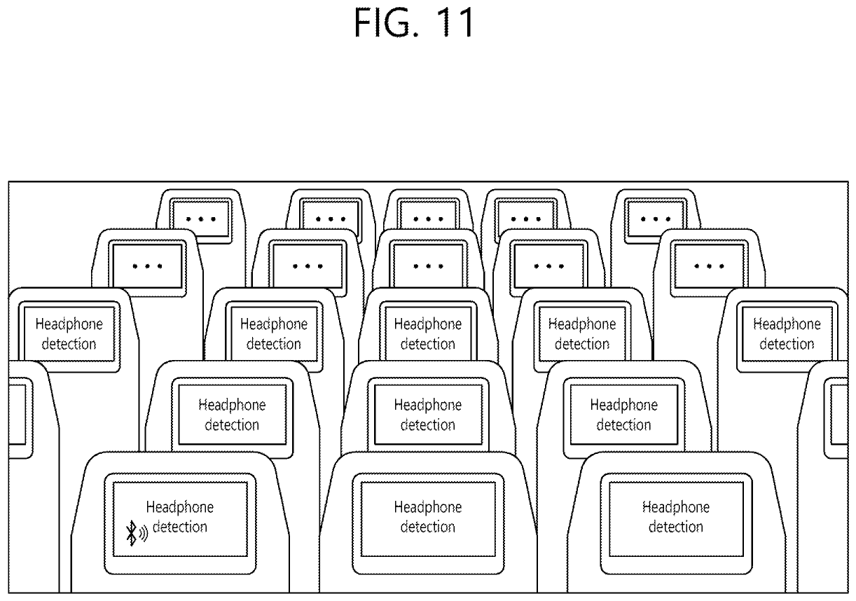

FIG. 11 is a diagram showing an example of a situation that occurs when a BLE device attempts to connect with an IFE device.

Referring to FIG. 11, a BLE device may transmit a BLE Advertising signal for connection with an IFE device. In an environment such as inside an airplane where several Bluetooth devices (e.g., IFE devices) are mixed around, all of the various Bluetooth devices (e.g., IFE devices) can receive BLE Advertising signals. Therefore, as shown in FIG. 10, since the IFE devices of other users other than the user's IFE device also receive the BLE advertising signal of the BLE device, a notification is displayed on all nearby IFE devices, causing inconvenience to other users.

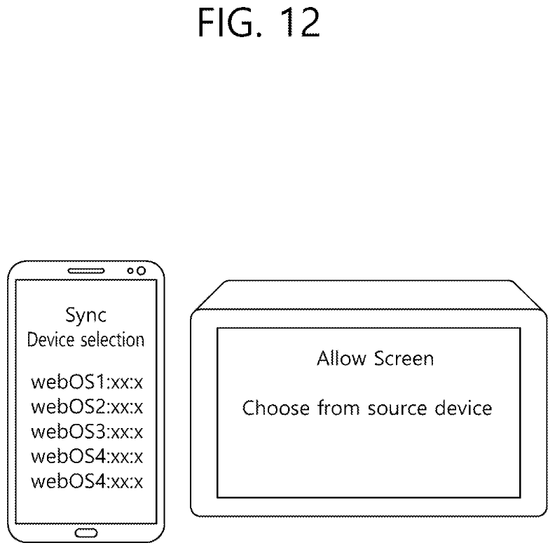

FIG. 12 is a diagram illustrating an example of a situation that occurs when an IFE device or a user terminal attempts to connect to an IFE device for mirroring.

Referring to FIG. 12, a user terminal may transmit a discovery signal for a mirroring connection with an IFE device. In an environment such as inside an airplane in which several display devices (e.g., IFE devices) are mixed around, all of the various display devices (e.g., IFE devices) may receive a discovery signal. Accordingly, since IFE devices of other users other than the user's IFE device also receive the mirroring discovery signal of the terminal, the terminal can search for several IFE devices. Accordingly, as shown in FIG. 12, several devices may be searched for, and it may be difficult for the user to know which device is the IFE device to which he/she intends to perform a mirroring connection.

Hereinafter, a method of providing a connection method between a personal portable electronic device (e.g., a Bluetooth headset, earphone) and an IFE device using a third device (e.g., a smartphone) will be described.

A connection method between a personal PED (e.g., the wireless device (Bluetooth headphones or earphones)) and the IFE device may be provided through a third device (e.g., terminal). Therefore, an individual who is already using a mobile phone The device can easily be used in IFE.

A control path is required to transfer between the connectivity information of the terminal (mobile phone) and the IFE, and a general method of creating a control path may be as follows.

The IFE device and terminal can recognize each other through a proximity network. For example, when a connection between two devices is attempted and completed, connectivity information may be exchanged. For example, connection between devices may be attempted through a proximity network (e.g., a quick response (QR) code and/or near field communication (NFC)). For example, devices may be connected to each other through a QR code, and connectivity information may be exchanged. The connection may be defined as Out Of Band (00B). Alternatively, connectivity information between devices may be exchanged through the NFC Peer To Peer mode.

For example, when a user gets on and sits down, a PED automatic discovery method that sets a control path by matching passenger information and IFE seat information through BLE may be used.

Connectivity information may include:

Information Delivered by Source

Bluetooth: Bonded information (Mac Address, Link Key, etc.)

Setting information on which device to connect (Screen Share/Bluetooth Headset)

Information Delivered by Sync

Screen Share: Sync's Screen Share Address

When the transmission of connectivity information is finished, the IFE device can terminate the control path.

The IFE device may request a connection to the terminal or a wireless device registered to the terminal based on the connectivity information received from the terminal.

When an IFE device tries to connect to a Bluetooth device registered in the terminal, the IFE device can perform whitelisting discovery based on the connectivity (Bluetooth Bonded information) received from the mobile phone. An IFE device can make a connection request when a personal PED (e.g., headset) is discovered.

When an IFE device wants to perform Screen Share with a device, the device (mobile phone) can request a screen share connection based on the connectivity (Screen Share information) received from the IFE device. When the IFE device and the terminal are connected, the terminal can be mirrored to the IFE device.

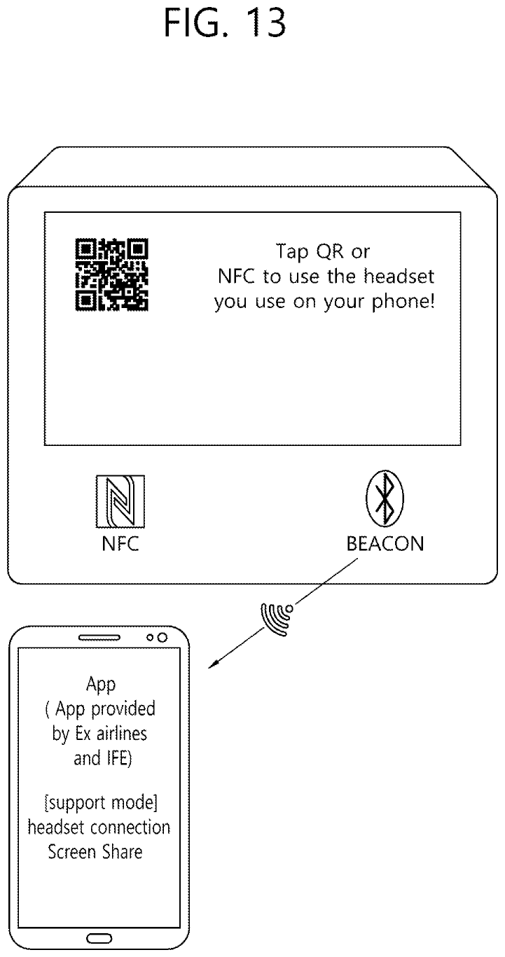

FIG. 13 is a diagram illustrating an embodiment of a method of operating an IFE device.

Referring to FIG. 13, the IFE device may transmit a Bluetooth beacon signal. For example, the Bluetooth beacon signal may be a Bluetooth low energy (BLE) advertising signal.

The terminal may receive a Bluetooth beacon signal from the IFE device. For example, the terminal may establish a Bluetooth connection with the IFE device based on a Bluetooth beacon signal received from the IFE device.

For example, the terminal provides connection information (e.g., media access control (MAC) address of the wireless device) related to a wireless device (e.g., a Bluetooth wireless headset or earphone) registered to the terminal through Bluetooth communication to the IFE device. link key information, setting information of a wireless device, etc.) may be transmitted. The IFE device may receive connection information related to a wireless device from a terminal.

For example, the IFE device may transmit control information related to mirroring (e.g., screen share address information) to the terminal through Bluetooth communication.

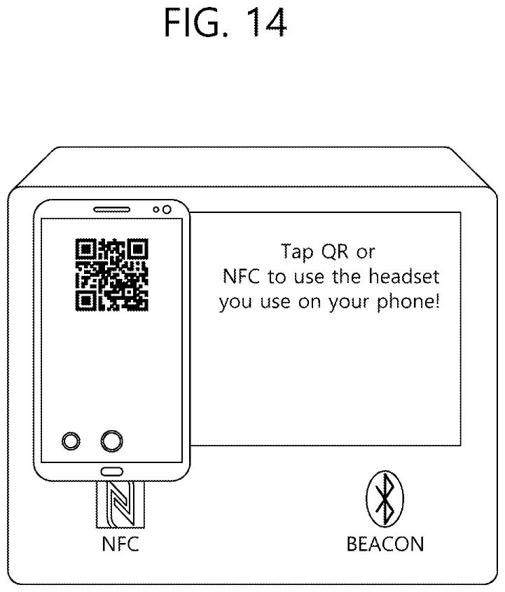

FIG. 14 is a diagram illustrating an embodiment of a method of operating an IFE device.

Referring to FIG. 14, the IFE device may provide a quick response (QR) code. For example, the IFE device may communicate with a base station or access point (AP), and the QR code may include information allowing the user terminal to transmit a signal to the IFE device through the base station or AP.

The terminal may obtain QR code information, and the terminal may transmit connection information (e.g., MAC (media access control) address of the wireless device, link key information, setting information of the wireless device, etc.) related to a wireless device (e.g., Bluetooth wireless headset, earphone) registered in the terminal to the IFE device through a base station or AP based on the QR code information. The IFE device may receive connection information related to a wireless device from a terminal.

For example, the terminal may transmit a signal requesting control information (e.g., screen share address information) related to mirroring from the IFE device to the IFE device through a base station or AP based on QR code information. The IFE device may transmit control information related to mirroring to the terminal through the base station or AP.

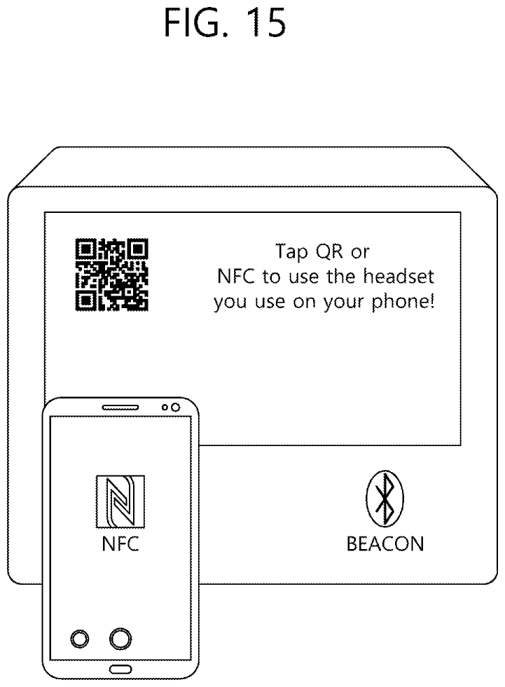

FIG. 15 is a diagram illustrating an embodiment of a method of operating an IFE device.

Referring to FIG. 15, the IFE device provides connection information (e.g., MAC of the wireless device) related to a wireless device (e.g., Bluetooth wireless headset, earphone) registered to the terminal through a near field communication (NFC) method from the terminal. (media access control) address, link key information, setting information of a wireless device, etc.) may be transmitted. The IFE device may receive connection information related to a wireless device from a terminal.

For example, the IFE device may transmit mirroring-related control information (e.g., screen share address information) to the terminal through the NFC scheme.

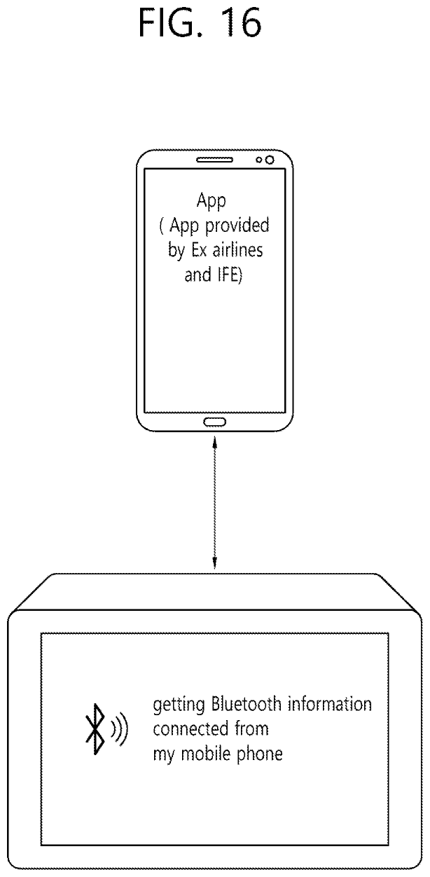

FIGS. 16 to 18 are diagrams illustrating an embodiment of an IFE device operation.

Referring to FIG. 16, for example, the IFE device provides connection information (e.g., MAC (media access control) address, link key information, setting information of a wireless device, etc.) may be received. For example, the IFE device may transmit control information related to mirroring (e.g., screen share address information) to the terminal.

For example, the terminal may connect with an IFE device using an application provided by an airline or an IFE, and may exchange information with the IFE device.

A method for the IFE device to receive control information related to mirroring and/or connection information of a wireless device registered to the terminal from the terminal may be based on the contents described with reference to FIGS. 13 to 15 above.

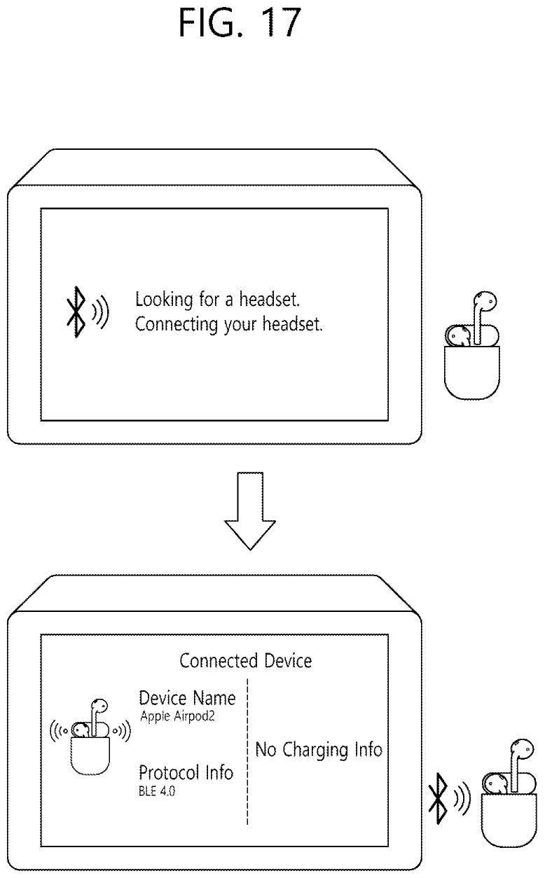

Referring to FIG. 17, the IFE device receives connection information (e.g., media access control (MAC)) address, link key information, setting information of the wireless device, etc.), it is possible to connect to the wireless device registered in the terminal.

For example, the IFE device may perform a pairing procedure with a wireless device in a unicast method rather than a broadcast method based on the connection information received from the terminal. For example, the IFE device may search for a wireless device based on the connection information (e.g., a discovery procedure), and may directly attempt to connect to a wireless device related to the connection information. That is, the IFE device may search for a plurality of devices through a Bluetooth search procedure, and perform a connection with a device that matches the connection information received from the terminal among the searched devices. Alternatively, for example, the IFE device may perform a direct connection without performing a discovery procedure for pairing with a wireless device based on the connection information.

Accordingly, the problems in FIGS. 10 and 11 can be solved.

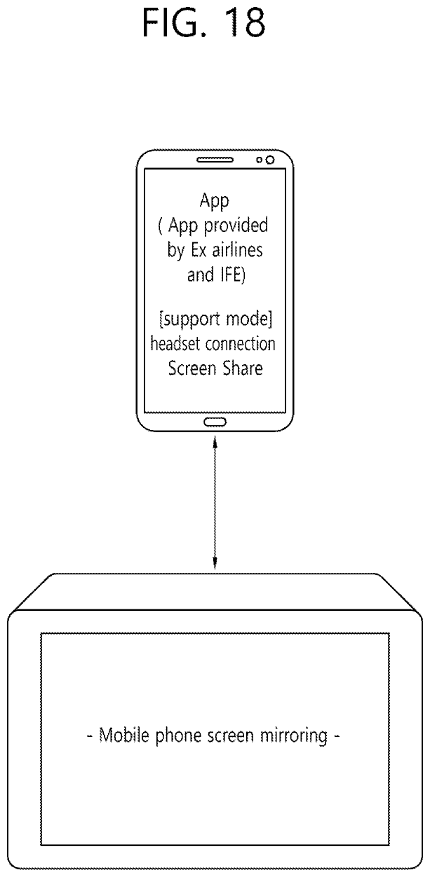

Referring to FIG. 18, the IFE device may perform a mirroring operation with the terminal based on control information (e.g., screen share address information) related to mirroring received from the terminal in FIG. 16.

For example, the terminal may connect with an IFE device using an application provided by an airline or an IFE, and may exchange information with the IFE device.

For example, the terminal may complete procedures S920 and S930 in FIG. 9 by acquiring control information related to mirroring from the IFE device, and may immediately perform a connection with the IFE device.

Therefore, the problem in FIG. 12 can be solved.

According to the embodiments of FIGS. 13 to 18, a connection method between a personal PED (e.g., the wireless device (Bluetooth headphones or earphones)) and an IFE device through a third device (e.g., terminal) can be provided. Therefore, personal devices already used in mobile phones can be easily used in IFE.

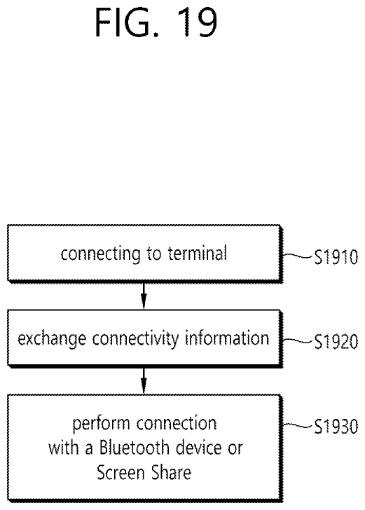

FIG. 19 is a flowchart illustrating an embodiment of a method of operating an IFE device.

Referring to FIG. 19, the IFE device may be connected to the terminal (S1910). The IFE device and terminal may be directly connected through Bluetooth, NFC, etc., or may exchange signals through a base station or AP.

For example, the IFE device may transmit a Bluetooth beacon signal. For example, the Bluetooth beacon signal may be a Bluetooth low energy (BLE) advertising signal. The terminal may receive a Bluetooth beacon signal from the IFE device. For example, the terminal may establish a Bluetooth connection with the IFE device based on a Bluetooth beacon signal received from the IFE device.

For example, the IFE device may provide a quick response (QR) code. For example, the IFE device may communicate with a base station or access point (AP), and the QR code may include information allowing the user terminal to transmit a signal to the IFE device through the base station or AP.

For example, the IFE device may be connected to the terminal through a near field communication (NFC) scheme.

The IFE device may exchange connectivity information with the terminal (S1920). Connectivity information may include:

Information Delivered by Source

Bluetooth: Bonded information (Mac Address, Link Key, etc.)

Setting information on which device to connect (Screen Share/Bluetooth Headset)

Information Delivered by Sync

Screen Share: Sync's Screen Share Address

When the transmission of connectivity information is finished, the IFE device can terminate the control path.

For example, the IFE device provides connection information (e.g., MAC (media access control) address of the wireless device, link key (link key) information, wireless device setting information, etc.) can be received. For example, the IFE device may transmit control information related to mirroring (e.g., screen share address information) to the terminal. For example, the IFE device may terminate the connection with the terminal after exchanging connectivity information with the terminal.

The IFE device may perform a connection with a Bluetooth device registered in the terminal or perform a Screen Share operation with the terminal (S1930).

For example, the IFE device may connect to a wireless device (e.g., Bluetooth wireless headset, earphone) registered in the terminal based on connection information (e.g., MAC (media access control) address of the wireless device, link key information, setting information of the wireless device, etc.) related to the wireless device registered in the terminal received from the terminal. For example, the IFE device may perform a pairing procedure with a wireless device in a unicast method rather than a broadcast method based on the connection information received from the terminal. For example, the IFE device may search for a wireless device based on the connection information (e.g., a discovery procedure), and may directly attempt to connect to a wireless device related to the connection information. That is, the IFE device may search for a plurality of devices through a Bluetooth search procedure, and perform a connection with a device that matches the connection information received from the terminal among the searched devices. Alternatively, for example, the IFE device may perform a direct connection without performing a discovery procedure for pairing with a wireless device based on the connection information.

For example, the IFE device may perform a mirroring operation with the terminal based on mirroring-related control information (e.g., screen share address information) received from the terminal. For example, the terminal may complete procedures S920 and S930 in FIG. 9 by acquiring control information related to mirroring from the IFE device, and may immediately perform a connection with the IFE device.

Some of the detailed steps shown in the example of FIG. 19 may not be essential steps and may be omitted. For example, in FIG. 19, the step of connecting to the terminal (S1910) may be omitted. For example, the order of the steps may vary. Some of the above steps may have their own technical meaning.

The technical features of the present specification described above may be applied to various devices and methods. For example, the technical features of the present specification described above may be performed/supported through the device of FIG. 2. For example, the technical features of the present specification described above may be applied only to a part of FIG. 2. For example, the technical features of the present disclosure may be implemented based on the processor 124 or the control unit 114 of FIG. 2, or implemented based on the Bluetooth interfaces 116 and 126, the input units 112 and 122, the output units 111 and 121, the memories 115 and 125, the communication units 118 and 127, the control unit 114 and the processor 124 of FIG. 2. For example, a device (or an apparatus) of the present specification includes a memory and a processor operatively coupled to the memory, the processor may be configured to receive a signal including connection information of a second device from a first device; and perform a connection with the wireless device based on the connection information.

The technical features of the present disclosure may be implemented based on a computer readable medium (CRM). For example, a CRM according to the present disclosure is at least one computer readable medium including instructions designed to be executed by at least one processor. The CRM may store instructions that perform operations including receiving a signal including connection information of a second device from a first device and performing a connection with the wireless device based on the connection information.

At least one processor may execute the instructions stored in the CRM according to the present disclosure. At least one processor related to the CRM of the present disclosure may be the processor 124 or the controller 114 of FIG. 2. Meanwhile, the CRM of the present disclosure may be the memories 115 and 125 of FIG. 1, or a separate external memory/storage medium/disk.

The foregoing technical features of the present specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in the present specification may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method in a wireless communication system supporting Bluetooth communication, the method comprising:
receiving, by an In Flight Entertainment (IFE) device, a signal including connection information of a second device from a first device; and
performing, by the IFE device, a connection with the second device based on the connection information.

2. The method of claim 1, wherein the IFE device receives a signal including the connection information from the first device through near field communication (NFC).

3. The method of claim 1, wherein the first device is a smartphone, and the second device is a wireless earphone or headset.

4. The method of claim 1, wherein the connection information includes at least one of a media access control (MAC) address of the second device, link key information, and setting information of the second device.

5. The method of claim 1, wherein the method further comprising:
searching, by the IFE device, the second device based on the connection information and a preset whitelist.

6. The method of claim 1, wherein the method further comprising:
transmitting, by the IFE device, a Bluetooth (BLE) advertising signal; and
performing, by the IFE device, a Bluetooth connection with the first device,
receiving, by the IFE device, the connection information from the first device through Bluetooth communication.

7. The method of claim 6, wherein the method further comprising:
terminating, by the IFE device, the Bluetooth connection with the first device when connected to the second device.

8. The method of claim 1, wherein the method further comprising:
transmitting, by the IFE device, screen share address information to the first device; and
performing, by the IFE device, mirroring with the first device based on the screen sharing address information.

9. An In Flight Entertainment (IFE) device used in a wireless communication system supporting Bluetooth communication, the IFE device comprising:
a transceiver for transmitting and receiving radio signals; and
a processor connected to the transceiver, wherein the processor is configured to:
receive a signal including connection information of a second device from a first device; and
perform a connection with the second device based on the connection information.

10. The IFE device of claim 9, wherein the processor is further configured to:
receive a signal including the connection information from the first device through near field communication (NFC).

11. The IFE device of claim 9, wherein the first device is a smartphone, and the second device is a wireless earphone or headset.

12. The IFE device of claim 9, wherein the connection information includes at least one of a media access control (MAC) address of the second device, link key information, and setting information of the second device.

13. The IFE device of claim 9, wherein the processor is further configured to:
search the second device based on the connection information and a preset whitelist.

14. The IFE device of claim 13, wherein the processor is further configured to:
transmit a Bluetooth (BLE) advertising signal; and
perform a Bluetooth connection with the first device,
receive the connection information from the first device through Bluetooth communication.

15. The IFE device of claim 12, wherein the processor is further configured to:
terminate the Bluetooth connection with the first device when connected to the second device.

16. The IFE device of claim 9, wherein the processor is further configured to:
transmit screen share address information to the first device; and
perform mirroring with the first device based on the screen sharing address information.

17-18. (canceled)
